(19) United States
(12) Patent Application Publication
(10) Pub. No.: US 2006/0251961 A1
(43) Pub. Date: Nov. 9, 2006

(54) Use of an ionic liquid

(75) Inventors: Gerhard Olbert, Dossenheim (DE); Torsten Mattke, Freinsheim (DE); Martin Fiene, Njederkirchen (DE); Oliver Huttenloch, Ispringen (DE); Ulrich Hammon, Mannheim (DE)

Correspondence Address: CONNOLLY BOVE LODGE & HUTZ, LLP, P O BOX 2207, WILMINGTON, DE, 19899, US

(73) Assignee: BASF AKTIENGESELLSCHAFT, Ludwigshafen (DE)

(21) Appl. No.: 10/552,567

(22) PCT Filed: Mar. 24, 2004
(86) PCT No.: PCT/EP04/03106

§ 371 Date: Nov. 3, 2005

(30) Foreign Application Priority Data
Apr. 10, 2003 (DE) 103164189

(51) Int. Cl. H01M 10/00

(52) U.S. Cl. 429/122

(57) ABSTRACT

The use of an ionic liquid as heat transfer medium for the indirect introduction or removal of heat into or from a reactor is described.

The invention relates to the use of an ionic liquid as heat transfer medium.

Chemical reactions frequently proceed with liberation or introduction of heat. The introduction or removal of heat is often carried out indirectly via a heat transfer medium which is kept separate from the reaction mixture. Heat transfer media are selected from among commercial products, in particular on the basis of the following necessary and desirable properties:
chemical stability in the desired pressure and temperature range,
favorable physical properties, in particular low viscosity, high density, high thermal conductivity and high specific heat,
low pour point or solidification temperature,
nonflammable,
noncorrosive,
when used without a change in physical state: low vapor pressure,
nontoxic and not irritating, no unpleasant odor,
low total costs, in particular in procurement, propping-up, care and replacement.
(According to Ullmanns Enzyklopädie der technischen Chemie, 4th edition, volume 2, Verlag Chemie, Weinheim, pages 446 to 449.)

Known, frequently used heat transfer media are water, alkali metal (sodium or potassium) melts, a mixture of 53% of potassium nitrate, 40% of sodium nitrite and 7% of sodium nitrate, which is known under the name high-temperature salt melt (HTS), organic heat transfer media, in particular the mixture of biphenyl and diphenyl oxide known as Diphyl, Diphyl O (ortho-dichlorobenzene) and also monochlorobenzene or mineral oils.

In many reactions, large quantities of heat have to be removed, which is frequently achieved using heat transfer media, for example water or other heat transfer media, which vaporize, i.e. remove heat via evaporative cooling. Here, the vapor pressure increases with increasing temperature level. For example, water vapor at 280° C. has a pressure of from 70 to 80 bar. However, pressure apparatuses are expensive, and for this reason liquid salt melts are generally used as heat transfer media for high temperatures, in particular in the range from about 280 to 400° C.

The above-described high-temperature salt melt is thermally stable up to about 480° C., but solidifies at temperatures below 142° C. The melting point increases with time due to carbonate formation in the salt. Its handling is therefore complicated: melting is generally carried out in a salt melt vessel, batchwise, and the melt is conveyed to the reactor by means of a pump or under nitrogen pressure. Frequently, only a substream of the high-temperature salt melt is fed into the reactor and the remaining high-temperature salt melt is conveyed via a bypass which likewise has to be heated. Furthermore, changing the catalyst is also complicated: to carry out this, all the high-temperature salt melt has to be removed from the reactor or, if the high-temperature salt melt is allowed to cool in the reactor, this has to be melted again, which consumes energy, before operation is restarted. The use of the high-temperature salt melt is thus associated with considerable apparatus costs and operating costs for starting up the reactor.

Furthermore, the high-temperature salt melt can be used in the integrated heat system of an overall plant only when using full heating of the pipes, since the salt mixture would otherwise solidify in the pipes.

The high-temperature salt melt is an oxidizing substance and in the case of leakages of the organic substances or substance mixtures from the reactor can thus lead to partial oxidations and even to fire and melt the reaction tubes. In general, the salt melt side of the reactors is operated at atmospheric pressure and the reaction tubes carrying the organic reaction mixture are operated under a slight to relatively high gauge pressure in order to avoid contamination of the reaction mixture by the salt melt. In the case of leaks in the tube walls, the organic reaction mixture automatically pushes through the point of the leak and reacts with the salt melt on the salt melt side.

For safe operation using the high-temperature salt melt, the pumps are installed at the top, i.e. they generally convey the melt from the top downward. This avoids direct contact of the shaft bearings and seals with the high-temperature salt melt, since reaction of the salt melt with the bearing grease can otherwise occur.

It is an object of the present invention to provide a heat transfer medium for reactors which does not have the abovementioned disadvantages. In particular, a heat transfer medium which is suitable for shell-and-tube reactors or reactors with heat-exchange plates, is liquid over a wide temperature range and also has the other necessary or favorable properties mentioned at the outset for heat transfer media, in particular favorable physical properties, especially a high density and a high specific heat, is to be provided.

We have found that this object is achieved by use of ionic liquids for this application.

According to the definition of Wasserscheid and Keim in Angewandte Chemie 2000, 112, 3926-3945, ionic liquids are salts which have a nonmolecular, ionic character and melt at relatively low temperatures. They are liquid even at relatively low temperatures and have a relatively low viscosity at such temperatures. They are very good solvents for a large number of organic, inorganic and polymeric substances. In addition, they are generally nonflammable, noncorrosive and do not have a measurable vapor pressure.

Usually, ionic liquids are substances with at least one of the two ions (cation and/or anion) being of organic nature, i.e. having at least one carbon atom.

Ionic liquids are compounds which are made up of positive and negative ions, but are overall electrically neutral. Both the positive ions and the negative ions are predominantly monovalent, but multivalent anions and/or cations, for example ions bearing from 1 to 5, preferably from 1 to 4, more preferably from 1 to 3 and very particularly preferably 1 or 2, electrical charges per ion are also possible. The charges can be located on various localized or delocalized regions within one molecule, i.e. in a betaine-like manner, or can be present on separate anions and cations. Preference is given to ionic liquids which are made up of at least one cation and at least one anion.

Known uses of ionic liquids are, in particular, as solvents for chemical reactions, as auxiliaries for separating acids from chemical reaction mixtures, as described in the German patent application number 10202838.9, which is not a prior publication, as auxiliaries for extractive rectification to separate mixtures having small boiling point differences or azeotropic mixtures, as described in WO 02/074718, or as heat transfer media in solar heating units, as described in Proceedings of Solar Forum, 2001, Apr. 21-25, Washington, D.C.

The invention is not restricted to specific ionic liquids; it is possible to use all suitable ionic liquids, including mixtures of various ionic liquids.

Preference is given to ionic liquids having a low melting point, in particular below 150° C., or below 140° C., or below 130° C., more preferably below 80° C., particularly preferably below 25° C.

Ionic liquids are advantageously used as heat transfer media at an operating temperature, i.e. a temperature range in which the ionic liquids are in the liquid state, of from +60° C. to 360° C., in particular from 260 to 360° C.

Preference is given to using ionic liquids of the formula
[A]ₙ⁺[Y]ⁿ⁻
where n=1, 2, 3 or 4 and
the cation [A] is selected from among
quaternary ammonium cations of the formula
   [NR¹R²R³R]⁺,
   phosphonium cations of the formula
      [PR¹R²R³R]⁺,
   imidazolium cations of the formula 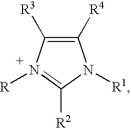
   and also all isomeric imidazolinium cations and imidazolidinium cations analogous to the above formula,
   H-pyrazolium cations of the formula 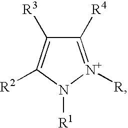
   and also 3H-pyrazolium cations, 4H-pyrazolium cations, 1-pyrazolinium cations, 2-pyrazolinium cations and 3-pyrazolinium cations,
   pyridinium cations of the formula 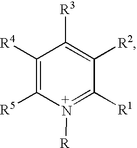
   and also pyridazinium, pyrimidinium and pyrazinium ions,
   pyrrolidinium cations of the formula 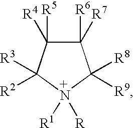
   five- to at least six-membered heterocyclic cations containing at least one phosphorus or nitrogen atom and possibly also an oxygen or sulfur atom, for example thiazolium, oxazolium, 1,2,4-triazolium or 1,2,3-triazolium, particularly preferably compounds comprising at least one five- to six-membered heterocycle containing one, two or three nitrogen atoms and a sulfur atom or an oxygen atom, very particularly preferably those having one or two nitrogen atoms,
   and the 1,8-diazabicyclo[5.4.0]undec-7-enium cation and also the 1,8-diazabicyclo[4.3.0]non-5-enium cation: 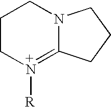
      and oligomers and polymers in which these cations are present, where the radicals R, R¹, R², R³, R⁴, R⁵, R⁶, R⁷, R⁸ and R⁹ are each, independently of one another, hydrogen, C1-C18-alkyl, C2-C18-alkyl which may be interrupted by one or more oxygen and/or sulfur atoms and/or one or more substituted or unsubstituted imino groups, C6-C12-aryl, C5-C12-cycloalkyl or a five- or six-membered, oxygen-, nitrogen- and/or sulfur-containing heterocycle or two or them together form an unsaturated, saturated or aromatic ring which may be interrupted by one or more oxygen and/or sulfur atoms and/or one or more substituted or unsubstituted imino groups, where the radicals mentioned may each be substituted by functional groups, aryl, alkyl, aryloxy, alkyloxy, halogen, heteroatoms and/or heterocycles.

Here, examples of C₁-C₁₈-alkyl which may be substituted by functional groups, aryl, alkyl, aryloxy, alkyloxy, halogen, heteroatoms and/or heterocycles are methyl, ethyl, propyl, isopropyl, n-butyl, sec-butyl, tert-butyl, pentyl, hexyl, heptyl, octyl, 2-ethylhexyl, 2,4,4-trimethylpentyl, decyl, dodecyl, tetradecyl, hexadecyl, octadecyl, 1,1-dimethylpropyl, 1,1-dimethylbutyl, 1,1,3,3-tetramethylbutyl, benzyl, 1-phenylethyl, 2-phenylethyl, α,α-dimethylbenzyl, benzhydryl, p-tolylmethyl, 1-(p-butylphenyl)ethyl, p-chlorobenzyl, 2,4-dichlorobenzyl, p-methoxybenzyl, m-ethoxybenzyl, 2-cyanoethyl, 2-cyanopropyl, 2-methoxycarbonylethyl, 2-ethoxycarbonylethyl, 2-butoxycarbonylpropyl, 1,2-di-(methoxycarbonyl)ethyl, 2-methoxyethyl, 2-ethoxyethyl, 2-butoxyethyl, diethoxymethyl, diethoxyethyl, 1,3-dioxolan-2-yl, 1,3-dioxan-2-yl, 2-methyl-1,3-dioxolan-2-yl, 4-methyl-1,3-dioxolan-2-yl, 2-isopropoxyethyl, 2-butoxypropyl, 2-octyloxyethyl, chloromethyl, 2-chloroethyl, trichloromethyl, trifluoromethyl, 1,1-dimethyl-2-chloroethyl, 2-methoxyisopropyl, 2-ethoxyethyl, butylthiomethyl, 2-dodecylthioethyl, 2-phenylthioethyl, 2,2,2-trifluoroethyl, 2-hydroxyethyl, 2-hydroxypropyl, 3-hydroxypropyl, 4-hydroxybutyl, 6-hydroxyhexyl, 2-aminoethyl, 2-aminopropyl, 3-aminopropyl, 4-aminobutyl, 6-aminohexyl, 2-methylaminoethyl, 2-methylaminopropyl, 3-methylaminopropyl, 4-methylaminobutyl, 6-methylaminohexyl, 2-dimethylaminoethyl, 2-dimethylaminopropyl, 3-dimethylaminopropyl, 4-dimethylaminobutyl, 6-dimethylaminohexyl, 2-hydrhoxy-2,2-dimethylethyl, 2-phenoxyethyl, 2-phenoxypropyl, 3-phenoxypropyl, 4-phenoxybutyl, 6-phenoxyhexyl, 2-methoxyethyl, 2-methoxypropyl, 3-methoxypropyl, 4-methoxybutyl, 6-methoxyhexyl, 2-ethoxyethyl, 2-ethoxypropyl, 3-ethoxypropyl, 4-ethoxybutyl and 6-ethoxyhexyl and

examples of C₂-C₁₈-alkyl interrupted by one or more oxygen atoms and/or sulfur atoms and/or one or more substituted or unsubstituted imino groups are 5-hydroxy-3-oxapentyl, 8-hydroxy-3,6-dioxaoctyl, 11-hydroxy-3,6,9-trioxaundecyl, 7-hydroxy-4-oxaheptyl, 11-hydroxy-4,8-dioxaundecyl, 15-hydroxy-4,8,12-trioxapentadecyl, 9-hydroxy-5-oxanonyl, 14-hydroxy-5,10-oxatetradecyl, 5-methoxy-3-oxapentyl, 8-methoxy-3,6-dioxaoctyl, 11-methoxy-3,6,9-trioxaundecyl, 7-methoxy-4-oxaheptyl, 11-methoxy-4,8-dioxaundecyl, 15-methoxy-4,8,12-trioxapentadecyl, 9-methoxy-5-oxanonyl, 14-methoxy-5,10-oxatetradecyl, 5-ethoxy-3-oxapentyl, 8-ethoxy-3,6-dioxaoctyl, 11-ethoxy-3,6,9-trioxaundecyl, 7-ethoxy-4-oxaheptyl, 11-ethoxy-4,8-dioxaundecyl, 15-ethoxy-4,8,12-trioxapentadecyl, 9-ethoxy-5-oxanonyl and 14-ethoxy-5,10-oxatetradecyl.

If two radicals form a ring, these radicals together can be 1,3-propylene, 1,4-butylene, 2-oxa-1,3-propylene, 1-oxa-1,3-propylene, 2-oxa-1,3-propylene, 1-oxa-1,3-propenylene, 1-aza-1,3-propenylene, 1-C₁-C₄-alkyl-1-aza-1,3-propenylene, 1,4-buta-1,3-dienylene, 1-aza-1,4-buta-1,3-dienylene or 2-aza-1,4-buta-1,3-dienylene.

The number of oxygen atoms and/or sulfur atoms and/or imino groups is not subject to any restrictions. It is generally not more than 5 per radical, preferably not more than 4 and very particularly preferably not more than 3.

Furthermore, at least one carbon atom, preferably at least two, is/are generally present between two heteroatoms.

Substituted and unsubstituted imino groups can be, for example, imino, methylimino, isopropylimino, n-butylimino or tert-butylimino.

Furthermore, functional groups can be carboxy, carboxamide, hydroxy, di(C₁-C₄-alkyl)-amino, C₁-C₄-alkyloxycarbonyl, cyano or C₁-C₄-alkyloxy,

C₆-C₁₂-aryl which may be substituted by functional groups, aryl, alkyl, aryloxy, alkyloxy, halogen, heteroatoms and/or heterocycles, for example phenyl, tolyl, xylyl, α-naphthyl, α-naphthyl, 4-diphenylyl, chlorophenyl, dichlorophenyl, trichlorophenyl, difluorophenyl, methylphenyl, dimethylphenyl, trimethylphenyl, ethylphenyl, diethylphenyl, isopropylphenyl, tert-butylphenyl, dodecylphenyl, methoxyphenyl, dimethoxyphenyl, ethoxyphenyl, hexyloxyphenyl, methylnaphthyl, isopropylnaphthyl, chloronaphthyl, ethoxynaphthyl, 2,6-dimethylphenyl, 2,4,6-trimethylphenyl, 2,6-dimethoxyphenyl, 2,6-dichlorophenyl, 4-bromophenyl, 2- or 4-nitrophenyl, 2,4- or 2,6-dinitrophenyl, 4-dimethylaminophenyl, 4-acetylphenyl, methoxyethylphenyl or ethoxymethylphenyl,

C₅-C₁₂-cycloalkyl which may be substituted by functional groups, aryl, alkyl, aryloxy, alkyloxy, halogen, heteroatoms and/or heterocycles, for example cyclopentyl, cyclohexyl, cyclooctyl, cyclododecyl, methylcyclopentyl, dimethylcyclopentyl, methylcyclohexyl, dimethylcyclohexyl, diethylcyclohexyl, butylcyclohexyl, methoxycyclohexyl, dimethoxycyclohexyl, diethoxycyclohexyl, butylthiocyclohexyl, chlorocyclohexyl, dichlorocyclohexyl, dichlorocyclopentyl or a saturated or unsaturated bicyclic system such as norbornyl or norbornenyl, a five- or six-membered, oxygen-, nitrogen- and/or sulfur-containing heterocycle, for example furyl, thienyl, pyrryl, pyridyl, indolyl, benzoxazolyl, dioxolyl, dioxyl, benzimidazolyl, benzthiazolyl, dimethylpyridyl, methylquinolyl, dimethylpyrryl, methoxyfuryl, dimethoxypyridyl, difluoropyridyl, methylthiophenyl, isopropylthiophenyl or tert-butylthiophenyl, and

C₁-C₄-alkyl, for example methyl, ethyl, propyl, isopropyl, n-butyl, sec-butyl or tert-butyl.

Preference is given to R, R¹, R², R³, R⁴, R⁵, R⁶, R⁷, R⁸ and R⁹ each being, independently of one another, hydrogen, methyl, ethyl, n-butyl, 2-hydroxyethyl, 2-cyanoethyl, 2-(methoxycarbonyl)ethyl, 2-(ethoxycarbonyl)ethyl, 2-(n-butoxycarbonyl)ethyl, benzyl, acetyl, dimethylamino, diethylamino or chlorine.

Use may also be made of mixed species

[A¹]⁺[A²]⁺[Y]²⁻, [A¹]⁺[A²]⁺[A³]⁺[Y]³⁻ or [A¹]⁺[A²]⁺[A³]⁺[A⁴]⁺[Y]⁴⁻

where A¹, A², A³ and A⁴ are selected independently from among the groups mentioned for [A].

It is also possible to use mixed species having metal cations

[A¹]⁺[A²]⁺[A³]⁺[M¹]⁺[Y]⁴⁻, [A¹]⁺[A²]⁺[M¹]⁺[M²]⁺[Y]⁴⁻,

[A¹]⁺[M¹]⁺[M²]⁺[M³]⁺[Y]⁴⁻, [A¹]⁺[A²]⁺[M¹]⁺[Y]³⁻, [A¹]⁺[M¹]⁺[M²]⁺[Y]³⁻,

[A¹]⁺[M¹]⁺[Y]²⁻, [A¹]⁺[A²]⁺[M⁴]²⁺[Y]⁴⁻, [A¹]⁺[M¹]⁺[M⁴]²⁺[Y]⁴⁻,

[A¹]⁺[M⁵]³⁺[Y]⁴⁻, [A¹]⁺[M⁴]²⁺[Y]³⁻

where M¹, M², M³ are monovalent metal cations, M⁴ is a divalent metal cation and M⁵ is a trivalent metal cation.

As anions, it is in principle possible to use all anions.

The anion [Y] is preferably selected from among
the group of halides or halogen-containing compounds of the formulae:
   Cl⁻, Br⁻, BF₄⁻, PF₆⁻, AlCl₄⁻, Al₂Cl₇⁻, FeCl₄⁻, BCl₄⁻, SbF₆⁻, AsF₆⁻, ZnCl₃⁻, SnCl₃⁻, CF₃SO₃⁻, (CF₃SO₃)₂N⁻, CF₃CO₂⁻, CCl₃CO₂⁻, CN⁻, SCN³¹, OCN⁻
the group of sulfates, sulfites and sulfonate of the formulae:
   SO₄²⁻, HSO₄⁻, SO₃²⁻, HSO₃⁻, R^{a}OSO₃⁻, R^{a}SO₃⁻
the group of phosphates of the formulae
   PO₄³⁻, HPO₄²⁻, H₂PO₄⁻, R^{a} PO₄²⁻, HR^{a}PO₄⁻, R^{a}R^{b}PO₄⁻
the group of phosphonates and phosphinate of the formulae:
   R^{a}HPO₃⁻, R^{a}R^{b}PO₂⁻, R^{a}R ^{b}PO₃⁻
the group of phosphites of the formulae:
   PO₃³⁻, HPO₃²⁻, H₂PO₃⁻, R^{a}PO₃²⁻, R^{a}HPO₃⁻, R^{a}R^{b}PO₃⁻
the group of phosphonites and phosphinites of the formulae:
   R^{a}R^{b}PO₂⁻, R^{a}HPO₂⁻, R^{a}R^{b}PO⁻, R^{a}HPO⁻
the group of carboxylic acids of the formula:
   R^{a}COO⁻
the group of borates of the formulae:
   BO₃³⁻, HBO₃²⁻, H₂BO₃³¹, R^{a}R^{b}BO₃⁻, R^{a}HBO₃⁻, R^{a} BO₃²⁻, R^{a}R^{b}R^{c}R^{d}B⁻,
the group of boronates of the formulae:
   R^{a}BO₂²⁻, R^{a}R^{b}BO⁻
the group of carbonates and carboxylic esters of the formulae:
   HCO₃⁻, CO₃²⁻, R^{a}CO₃⁻
the group of silicates and silicic esters of the formulae:
   SiO₄⁴⁻, HSiO₄³⁻, H₂SiO₄²⁻, H₃SiO₄⁻, R^{a}SiO₄³⁻, R^{a}R^{b}SiO₄²⁻, R^{a}R^{b}R^{c}SiO₄⁻, HR^{a}SiO₄²⁻, H₂R^{a}SiO₄⁻, HR^{a}R^{b}SiO₄⁻
the group of alkylsilane and arylsilane salts of the formulae:
   R^{a}SiO₃³⁻, R^{a}R^{b}SiO₂²⁻, R^{a}R^{b}R^{c}SiO⁻, R^{a}R^{b}R^{c}SiO₃⁻, R^{a}R^{b}R^{c}SiO₂⁻, R^{a}R^{b}SiO₃ ²⁻
the group of carboximides, bis(sulfonyl)imides and sulfonylimides of the formulae: 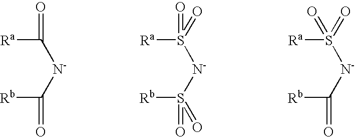
the group of alkoxides and aryloxides of the formula:
   R^{a}O⁻
the group of complex metal ions such as Fe(CN)₆³⁻, Fe(CN)₆⁴⁻, MnO₄⁻, Fe(CO)₄⁻,
   where the radicals R^{a}, R^{b}, R^{c}, R^{d} are each, independently of one another, C1-C18-alkyl, C2-C18-alkyl which may be interrupted by one or more oxygen atoms and/or sulfur atoms and/or one or more substituted or unsubstituted imino groups, C6-C12-aryl, C5-C12-cycloalkyl or a five- or six-membered, oxygen-, nitrogen- and/or sulfur-containing heterocycle or two of them together form an unsaturated, saturated or aromatic ring which may be interrupted by one or more oxygen and/or sulfur atoms and/or one or more substituted or unsubstituted imino groups, where the radicals mentioned may each be substituted by functional groups, aryl, alkyl, aryloxy, alkyloxy, halogen, heteroatoms and/or heterocycles.

Here, examples of C₁-C₁₈-alkyl which may be substituted by functional groups, aryl, alkyl, aryloxy, alkyloxy, halogen, heteroatoms and/or heterocycles are methyl, ethyl, propyl, isopropyl, n-butyl, sec-butyl, tert-butyl, pentyl, hexyl, heptyl, octyl, 2-ethylhexyl, 2,4,4-trimethylpentyl, decyl, dodecyl, tetradecyl, hexadecyl, octadecyl, 1,1-dimethylpropyl, 1,1-dimethylbutyl, 1,1,3,3-tetramethylbutyl, benzyl, 1-phenylethyl, 2-phenylethyl, α,α-dimethylbenzyl, benzhydryl, p-tolylmethyl, 1-(p-butylphenyl)ethyl, p-chlorobenzyl, 2,4-dichlorobenzyl, p-methoxybenzyl, m-ethoxybenzyl, 2-cyanoethyl, 2-cyanopropyl, 2-methoxycarbonylethyl, 2-ethoxycarbonylethyl, 2-butoxycarbonylpropyl, 1,2-di-(methoxycarbonyl)ethyl, 2-methoxyethyl, 2-ethoxyethyl, 2-butoxyethyl, diethoxymethyl, diethoxyethyl, 1,3-dioxolan-2-yl, 1,3-dioxan-2-yl, 2-methyl-1,3-dioxolan-2-yl, 4-methyl-1,3-dioxolan-2-yl, 2-isopropoxyethyl, 2-butoxypropyl, 2-octyloxyethyl, chloromethyl, 2-chloroethyl, trichloromethyl, trifluoromethyl, 1,1-dimethyl-2-chloroethyl, 2-methoxyisopropyl, 2-ethoxyethyl, butylthiomethyl, 2-dodecylthioethyl, 2-phenylthioethyl, 2,2,2-trifluoroethyl, 2-hydroxyethyl, 2-hydroxypropyl, 3-hydroxypropyl, 4-hydroxybutyl, 6-hydroxyhexyl, 2-aminoethyl, 2-aminopropyl, 3-aminopropyl, 4-aminobutyl, 6-aminohexyl, 2-methylaminoethyl, 2-methylaminopropyl, 3-methylaminopropyl, 4-methylaminobutyl, 6-methylaminohexyl, 2-dimethylaminoethyl, 2-dimethylaminopropyl, 3-dimethylaminopropyl, 4-dimethylaminobutyl, 6-dimethylaminohexyl, 2-hydroxy-2,2-dimethylethyl, 2-phenoxyethyl, 2-phenoxypropyl, 3-phenoxypropyl, 4-phenoxybutyl, 6-phenoxyhexyl, 2-methoxyethyl, 2-methoxypropyl, 3-methoxypropyl, 4-methoxybutyl, 6-methoxyhexyl, 2-ethoxyethyl, 2-ethoxypropyl, 3-ethoxypropyl, 4-ethoxybutyl and 6-ethoxyhexyl and

examples of C₂-C₁₈-alkyl interrupted by one or more oxygen atoms and/or sulfur atoms and/or one or more substituted or unsubstituted imino groups are 5-hydroxy-3-oxapentyl, 8-hydroxy-3,6-dioxaoctyl, 11-hydroxy-3,6,9-trioxaundecyl, 7-hydroxy-4-oxaheptyl, 11-hydroxy-4,8-dioxaundecyl, 15-hydroxy-4,8,12-trioxapentadecyl, 9-hydroxy-5-oxanonyl, 14-hydroxy-5,10-oxatetradecyl, 5-methoxy-3-oxapentyl, 8-methoxy-3,6-dioxaoctyl, 11-methoxy-3,6,9-trioxaundecyl, 7-methoxy-4-oxaheptyl, 11-methoxy-4,8-dioxaundecyl, 15-methoxy-4,8,12-trioxapentadecyl, 9-methoxy-5-oxanonyl, 14-methoxy-5,10-oxatetradecyl, 5-ethoxy-3-oxapentyl, 8-ethoxy-3,6-dioxaoctyl, 11-ethoxy-3,6,9-trioxaundecyl, 7-ethoxy-4-oxaheptyl, 11-ethoxy-4,8-dioxaundecyl, 15-ethoxy-4,8,12-trioxapentadecyl, 9-ethoxy-5-oxanonyl and 14-ethoxy-5,10-oxatetradecyl.

If two radicals form a ring, these radicals together can be 1,3-propylene, 1,4-butylene, 2-oxa-1,3-propylene, 1-oxa-1,3-propylene, 2-oxa-1,3-propylene, 1-oxa-1,3-propenylene, 1-aza-1,3-propenylene, 1-C₁-C₄-alkyl-1-aza-1,3-propenylene, 1,4-buta-1,3-dienylene, 1-aza-1,4-buta-1,3-dienylene or 2-aza-1,4-buta-1,3-dienylene.

The number of oxygen atoms and/or sulfur atoms and/or imino groups is not subject to any restrictions. It is generally not more than 5 per radical, preferably not more than 4 and very particularly preferably not more than 3.

Furthermore, at least one carbon atom, preferably at least two, is/are generally present between two heteroatoms.

Substituted and unsubstituted imino groups can be, for example, imino, methylimino, isopropylimino, n-butylimino or tert-butylimino.

Furthermore, functional groups can be carboxy, carboxamide, hydroxy, di(C₁-C₄-alkyl)-amino, C₁-C₄-alkyloxycarbonyl, cyano or C₁-C₄-alkyloxy,

C₆-C₁₂-aryl which may be substituted by functional groups, aryl, alkyl, aryloxy, alkyloxy, halogen, heteroatoms and/or heterocycles, for example phenyl, tolyl, xylyl, α-naphthyl, α-naphthyl, 4-diphenylyl, chlorophenyl, dichlorophenyl, trichlorophenyl, difluorophenyl, methylphenyl, dimethylphenyl, trimethylphenyl, ethylphenyl, diethylphenyl, isopropylphenyl, tert-butylphenyl, dodecylphenyl, methoxyphenyl, dimethoxyphenyl, ethoxyphenyl, hexyloxyphenyl, methylnaphthyl, isopropylnaphthyl, chloronaphthyl, ethoxynaphthyl, 2,6-dimethylphenyl, 2,4,6-trimethylphenyl, 2,6-dimethoxyphenyl, 2,6-dichlorophenyl, 4-bromophenyl, 2- or 4-nitrophenyl, 2,4- or 2,6-dinitrophenyl, 4-dimethylaminophenyl, 4-acetylphenyl, methoxyethylphenyl or ethoxymethylphenyl,

C₅-C₁₂-cycloalkyl which may be substituted by functional groups, aryl, alkyl, aryloxy, alkyloxy, halogen, heteroatoms and/or heterocycles, for example cyclopentyl, cyclohexyl, cyclooctyl, cyclododecyl, methylcyclopentyl, dimethylcyclopentyl, methylcyclohexyl, dimethylcyclohexyl, diethylcyclohexyl, butylcyclohexyl, methoxycyclohexyl, dimethoxycyclohexyl, diethoxycyclohexyl, butylthiocyclohexyl, chlorocyclohexyl, dichlorocyclohexyl, dichlorocyclopentyl or a saturated or unsaturated bicyclic system such as norbornyl or norbornenyl, a five- or six-membered, oxygen-, nitrogen- and/or sulfur-containing heterocycle, for example furyl, thienyl, pyrryl, pyridyl, indolyl, benzoxazolyl, dioxolyl, dioxyl, benzimidazolyl, benzthiazolyl, dimethylpyridyl, methylquinolyl, dimethylpyrryl, methoxyfuryl, dimethoxypyridyl, difluoropyridyl, methylthiophenyl, isopropylthiophenyl or tert-butylthiophenyl, and

C₁-C₄-alkyl, for example methyl, ethyl, propyl, isopropyl, n-butyl, sec-butyl or tert-butyl.

Preference is given to R¹, R², R³, R⁴ and R⁵ each being, independently of one another, hydrogen, methyl, ethyl, n-butyl, 2-hydroxyethyl, 2-cyanoethyl, 2-(methoxycarbonyl)ethyl, 2-(ethoxycarbonyl)ethyl, 2-(n-butoxycarbonyl)ethyl, dimethylamino, diethylamino or chlorine.

Particular preference is given to ionic liquids which are noncorrosive or even have a passivating action. These include, in particular, ionic liquids having sulfate, phosphate, borate or silicate anions. Solutions of inorganic salts in ionic liquids and metal-cation-containing ionic liquids of the type [A¹]⁺[M¹]⁺[Y]²⁻, which give improved thermal stability of the ionic liquid, are particularly preferred. Alkali metals and alkaline earth metals or their salts are very particularly preferred for this purpose.

Particular preference is given to ionic liquids which have an imidazolium cation, a pyridinium cation or a phosphonium cation as cation.

Ionic liquids, containing as a cation an imidazolium or substituted imidazolium cation and as anion hydrogen sulfate, are particularly preferred, especially 1-butyl-3-ethyl-imidazolium hydrogen sulfate, distinguished by a high density (of about 1.25 kg/dm³ at 100° C.) and a high heat capacity (cₚ of about 2.1 J/g·K at 100° C.).

Particularly suited are also ionic liquids, containing as anions tetraalkyl-, tetraaryl- or tetraalky-aryl-borates, especially 1-butyl-3-methyl-imidazolium-tetraphenylborate, with a particularly high heat capacity of up to 4 J/g·K at 100° C.

In a particularly preferred embodiment, the ionic liquid is used as heat transfer medium for the direct introduction or removal of heat into/from a shell-and-tube reactor.

The customary construction of shell-and-tube reactors comprises a generally cylindrical vessel in which a bundle, i.e. a plurality, of reaction tubes is accommodated, usually in a vertical arrangement. These reaction tubes, which may contain supported catalysts, have their ends sealed into tube plates and open into a cap connected to the upper or lower end of the vessel. The reaction mixture flowing through the reaction tubes is introduced or discharged via the caps. A heat transfer medium is circulated through the space surrounding the reaction tubes to provide or remove heat, especially in the case of reactions which are strongly exothermic. For economic reasons, reactors having a very large number of reaction tubes are used, and the number of reaction tubes accommodated within the shell is preferably in the range from 10000 to 30000 (cf. DE-A 44 31 949).

As regards the heat transfer medium circuit, it is known that a largely homogeneous temperature distribution in the heat transfer medium should be achieved in each horizontal section through the reactor so that virtually all reaction tubes participate equally in the reaction (e.g. DE-B 16 01 162). The smoothing of the temperature distribution is achieved by introduction or removal of heat via ring lines which are installed at each end of the reactor and have a plurality of openings in their wall, as are described, for example, in DE-B 34 09 159.

A further improvement in heat transfer is achieved by the installation of deflection plates which alternately leave open part of the reactor cross section in the middle of the reactor and at the edge of the reactor. Such an arrangement is particularly useful for annular tube bundles having a free central area and is known, for example, from GB-B 31 01 75.

The invention is not restricted to the abovementioned embodiments of shell-and-tube reactors, in particular not to the cylindrical reactor geometry, but can be applied generally to shell-and-tube reactors.

An advantage is that ionic liquids have particularly good physical properties, in particular in respect of the product of density and heat capacity: comparison of the critical physical properties of the classical salt melt composed of potassium nitrate and sodium nitrite with those for the ionic liquid 1-methyl-3-octylimidazolium hexafluorophospate (C₈ mim)(PF₆)

| | | | Density × cₚ |
|---|---|---|---|
| | Density [kg/m³] | cₚ [J/kg/K] | [J/m³/K] |
| Classical salt melt | 1820 | 1560 | 2 839 200 |
| (KNO₃/NaNO₂) | | | |
| Ionic liquid | 1400 | 2500 | 3 500 000 |
| (C₈mim)(PF₆) | | | |

shows that, at the same circulation rate, the ionic liquid can take up about 23.3% more heat than can the classical salt melt. This has a series of process engineering advantages. Firstly, the difference in temperature of the heat transfer medium between reactor inlet and reactor outlet is about ⅕ lower, so that the radial temperature difference between the reaction tubes over the cross section of the tube bundle becomes lower and the desired largely homogeneous temperature distribution over the reactor cross section, i.e. an isothermal reactor cross section, is improved. As a result, it is possible to reduce the maximum hot spot temperature difference between the individual reaction tubes, for example in the oxidation reaction for preparing phthalic anhydride, from about 15° C. in known shell-and-tube reactors to about 10° C. This leads to improved selectivity of the reaction and therefore to an increase in the yield. In addition, the capacity of the reactor can be increased by up to 2% without endangering operational safety.

Furthermore, the improved heat uptake by the heat transfer medium used according to the present invention, for example by 23.3%, results in the amount of heat transfer medium required for removing the same quantity of heat being reduced correspondingly, i.e. for example by 23.3%. This gives tremendous economic advantages, in particular a saving in the power required by the pumps.

In addition, ionic liquids are generally nontoxic and nonflammable. Their use is not restricted to a specific pump arrangement since contact with the bearing grease of the pumps is generally not critical. Standard pumps having relatively large delivery heads can be used for ionic liquids, and additional sealing of the pumps can be achieved by means of a barrier liquid which can likewise be an ionic liquid.

The ionic liquids can also be used advantageously as heat transfer media in reactors which are equipped with heat-exchange plates through which the heat transfer medium flows. Such reactors are described, for example, in DE-A 199 52 964.

The use of ionic liquids as heat transfer media in reactors for carrying out exothermic reactions, in particular partial oxidations, particularly preferably for the preparation of acrylein, acrylic acid, phthalic anhydride, maleic anhydride, or for the preparation of chlorine by oxidation of hydrogen chloride, is particularly advantageous.

In particular, ionic liquids can be used for replacing the classical high-temperature salt melt defined at the outset, for replacing heat transfer oils, monochlorobenzene and for replacing heat transfer media which are used for evaporative cooling or for condensation from vapor in all known applications of these heat transfer media in reactors. For example, the Marlotherm heat transfer oils used hitherto in the preparation of acrylonitrile-benzene-styrene (ABS) or polyamide 6.6 or the monochlorobenzene used in the preparation of phosgene can be replaced by ionic liquids.

1-10. (canceled)

11. A method of using of an ionic liquid as heat transfer medium for the indirect introduction or removal of heat into or from a reactor.

12. A method of using as claimed in claim 11, wherein the ionic liquid has a melting point below 150° C.

13. A method of using as claimed in claim 11, wherein the ionic liquid used as heat transfer medium has an operating temperature in the range from +60° C. to 360° C.

14. A method of using as claimed in claim 11, wherein the reactor is a shell-and-tube reactor.

15. A method of using as claimed in claim 11, wherein the reactor is equipped with heat-exchange plates through which the ionic liquid flows as heat transfer medium.

16. A method of using as claimed in claim 11, wherein the ionic liquid contains a sulfate, phosphate, borate or silicate anion.

17. A method of using as claimed in claim 16, wherein the ionic liquid contains a monovalent metal cation and a further cation.

18. A method of using as claimed in claim 11, wherein the ionic liquid contains an imidazolium cation, pyridinium cation or phosphonium cation.

19. A method of using as claimed in claim 11 for removing the heat of reaction of an exothermic reaction.

20. A method of using as claimed in claim 11, wherein the ionic liquid replaces a high-temperature salt melt, a heat transfer oil, monochlorobenzene or a heat transfer medium used for evaporative cooling or for the condensation of vapor.

21. A method of using as claimed in claim 12, wherein the ionic liquid has a melting point below 80° C.

22. A method of using as claimed in claim 21, wherein the ionic liquid has a melting point below 25° C.

23. A method of using as claimed in claim 13, wherein the ionic liquid has an operating temperature range from 260 to 360° C.

24. A method of using as claimed in claim 17, wherein the monovalent metal cation is an alkali metal cation and the further cation is an imidazolium cation.

25. A method of using as claimed in claim 19, wherein the exothermic reaction is a partial oxidation or the preparation of chlorine by oxidation of hydrogen chloride.

26. A method of using as claimed in claim 25, wherein the partial oxidation is the preparation of acrolein, acrylic acid, phthalic anhydride or maleic anhydride.
